(19) United States
(12) Patent Application Publication
(10) Pub. No.: US 2026/0151796 A1
(43) Pub. Date: Jun. 4, 2026

(54) CONTROL OF HIGHLY INTEGRATED WIRELESS ULTRASONIC MOTOR SYSTEMS WITH AUTONOMOUS FREQUENCY ADAPTIVE PULSE STEP MODULATION

(71) Applicant: The Hong Kong Polytechnic University, Kowloon (HK)

(72) Inventors: Zhiwei Xue, Kowloon (HK); Kwok Tong Chau, Kowloon (HK); Wei Liu, Kowloon (HK); Ye Duan, Kowloon (HK); Xiaotian Xie, Kowloon (HK)

(21) Appl. No.: 19/348,766

(22) Filed: Oct. 2, 2025

Related U.S. Application Data
(60) Provisional application No. 63/727,045, filed on Dec. 2, 2024.

(51) Int. Cl. B06B 1/04; B06B 1/02; H02J 50/10

(52) U.S. Cl. CPC B06B 1/04; B06B 1/0223; H02J 50/10

(57) ABSTRACT

This disclosure relates to a highly integrated wireless ultrasonic motor (USM) system, comprising: a high-frequency inverter configured to convert DC power into high-frequency AC power; a first and second wireless power transfer channel connected to the inverter respectively, wherein the first wireless power transfer channel includes a first transmitting and receiving coils directly connected to a stator of the motor, and the second wireless power transfer channel includes a second transmitting and receiving coils directly connected to the stator, and wherein the stator resonates with the receiving coils when excited by a high-frequency magnetic field, generating a driving AC voltage; an autonomous optimal frequency adaptation control unit configured to detect zero-crossings of an inverter output current and to generate drive trigger commands to adjust a motor driving frequency; and a frequency-adaptive pulse step modulation (FAPSM) unit configured to dynamically adjust a pulse step amplitude and frequency of the output voltage of the inverter.

### CROSS REFERENCE TO RELATED APPLICATION

This application claims the benefit of U.S. Provisional Patent Application Ser. No. 63/727,045, filed Dec. 2, 2024, the disclosure of which is incorporated by reference herein in its entirety.

### TECHNICAL FIELD

The present disclosure generally relates to a drive control system and method for a wireless ultrasonic motor. More particularly, the present disclosure relates to a wireless ultrasonic motor (USM) drive control system with autonomous frequency adaptive pulse step modulation.

### BACKGROUND

Wireless power transfer (WPT) is a transformative technology that allows the transmission of electrical energy without the need for physical connections or wires. This capability has evolved significantly, driven by advancements in electromagnetic theories and power electronic technologies.

Two prominent techniques in the WPT field are inductive power transfer (IPT) and capacitive power transfer (CPT), each employing distinct principles for energy transmission. IPT relies on electromagnetic induction, where alternating current in the transmitting coils creates magnetic fields that induce current in the receiving coils, enabling energy transfer without physical connections. This method is widely used in consumer electronics, electric vehicle charging, and medical devices due to its high efficiency and convenience over short distances. Conversely, CPT operates through electric field coupling between two pairs of plates. When the high-frequency alternating voltage is applied to one plate, an induced voltage can be generated on the other plate. However, compared with IPT technology, the two pairs of coupled plates inevitably occupy a larger space, which is not conducive to integration and miniaturization.

Recently, WPT technology has expanded into motor drive systems, which combine wireless power transmission with motor drive operation, enabling wireless power supply and wireless control of the motor without physical connection, batteries, and controllers at the receiving end. This innovative approach eliminates the limitations of a wired connection and increases flexibility in motor location, especially in applications requiring mobility such as robotic joints and electric vehicles. Moreover, by removing physical connectors, wireless motor systems reduce electrical hazards and improve safety in environments where traditional wiring may pose risks.

Recent advancements have led to the development of methods to wirelessly power and control brushless DC motors, wireless switched reluctance motors, and wireless permanent magnet synchronous motors, achieving smooth operation and precise speed control of motors. However, these wireless motors often require complex peripheral circuits, including multiple compensation components and semiconductor devices, which increase system complexity and maintenance costs. Additionally, coupling mechanisms tend to be bulky and heavy, hindering efforts toward miniaturization and integration.

A recent breakthrough involves a wireless USM that simplifies the system structure by eliminating the need for semiconductor devices at the receiving end, thus reducing complexity and cost. USMs operate at high frequencies, allowing the high-frequency alternating current transmitted by the WPT method to be used directly to drive the motor without secondary energy conversion. However, the wireless USM system is essentially an open-loop system. It should be pointed out that the equivalent impedance of the USM varies with the operation time, load, temperature, and other factors. This variability results in a constantly varying of the optimal driving frequency of USM. However, the single resonant frequency of WPT systems makes stable operation of wireless USM at its peak performance challenging and may jeopardize system feasibility. Furthermore, there is a lack of flexible voltage control methods for wireless USM drives.

Despite the significant potential of wireless USM systems, several challenges remain. To realize widespread applications, there is a need to address the issues of optimal drive frequency adaptive control and stepless regulation of the drive voltage in different driving frequencies.

### SUMMARY

The present disclosure provides a wireless USM system, specifically focusing on the design and control of highly integrated wireless USM systems that utilize autonomous frequency adaptive pulse step modulation to automatically adjust the driving frequency and voltage of USMs for improved performance of wireless USMs in various applications.

According to the first aspect of the present application, there is provided a drive control circuit for a wireless USM, comprising a high-frequency inverter configured to receive DC power and convert the DC power into high-frequency AC power and at least one power conversion stage, the power conversion stage comprising: a transmitter electrically connected to the high-frequency inverter, the transmitter including: a transmitting coil, and a compensation unit electrically connected between the high-frequency inverter and the transmitting coil, wherein the transmitter is configured to cause the transmitting coil to generate a high-frequency magnetic field in response to the high-frequency AC power; and a receiver including a receiving coil directly and electrically connected to a stator of the USM; wherein, in response to the high-frequency magnetic field generated by the transmitting coil, the receiving coil is configured to resonate with the stator, thereby generating a high-frequency AC voltage across the stator.

In an illustrative embodiment, the drive control circuit further comprises an inductor connected in series with the receiving coil and/or a capacitor connected in parallel with the ultrasonic motor.

In an illustrative embodiment, the drive control circuit further comprises an additional power conversion stage electrically independent of the at least one power conversion stage, wherein the at least one power conversion stage and the additional power conversion stage have the same topology. Illustratively, the additional power conversion stage comprises: an additional transmitter electrically connected to the high-frequency inverter, the additional transmitter including: an additional transmitting coil, and an additional compensation unit connected between the high-frequency inverter and the additional transmitting coil, wherein the additional transmitter is configured to cause the additional transmitting coil to generate an additional high-frequency magnetic field in response to the high-frequency AC power; and an additional receiver including an additional receiving coil directly and electrically connected to the stator of the USM; wherein, in response to the additional high-frequency magnetic field generated by the additional transmitting coil, the additional receiving coil is configured to resonate with the stator, thereby generating an additional high-frequency AC voltage across the stator.

Illustratively, the transmitting coil and the additional transmitting coil are vertically stacked to form a dual-coil structure, and the receiving coil and the additional receiving coil are vertically stacked to form an additional dual-coil structure. Illustratively, the compensation unit comprises a compensation capacitor, the compensation capacitor connected in series with the transmitting coil, forming a series resonant circuit to provide resonance compensation; and the additional compensation unit comprises an additional compensation capacitor, the additional compensation capacitor connected in series with the additional transmitting coil, forming an additional series resonant circuit to provide resonance compensation.

In an illustrative embodiment, a drive voltage applied to the at least one power conversion stage by the high-frequency inverter maintains a 90-degree phase difference from a drive voltage applied to the additional power conversion stage by the high-frequency inverter.

In an illustrative embodiment, the drive control circuit further comprises an autonomous optimal frequency adaptation control unit, configured to: detect a zero-crossing of an output current of the inverter; and based on the detection of the zero-crossing, to generate a drive trigger command, thereby triggering the inverter to adjust its frequency adaptively to operate autonomously at an optimal drive frequency of the USM by maintaining an output voltage and the output current of the inverter substantially in phase. Illustratively, the autonomous optimal frequency adaptation control unit comprises: a current sensor electrically connected to an output of the inverter and configured to sample the output current of the inverter; a zero-crossing comparator, communicatively coupled to the current sensor, and configured to output the trigger command upon detecting the zero-crossing of the sampled output current.

In a further illustrative or alternative embodiment, the drive control circuit comprises a frequency-adaptive pulse step modulation (FAPSM) unit configured to dynamically adjust a pulse step amplitude and frequency of the output voltage of the inverter, thereby providing stepless voltage control for the motor.

Illustratively, the FAPSM unit comprises: a Σ-Δ modulator configured to generate a pulse step modulation signal indicating a requirement for a full-pulse step (F) or a zero-pulse step (Z) based on a target voltage ratio (δ*); and a multiplier, operatively coupled to the Σ-Δ modulator and the autonomous optimal frequency adaptation control unit, and configured to receive the pulse step modulation signal from the Σ-Δ modulator and the trigger command from the autonomous optimal frequency adaptation control unit, so as to determine switching mode of the high-frequency inverter.

Illustratively, the Σ-Δ modulator comprises: an adder configured to compute a difference between the target voltage ratio (δ*) and a comparator output (y); an integrator configured to integrate an output (e) of the adder to produce an integrated output (u); and a comparator configured to: output a signal indicating the full-pulse step (F) if the integrated output (u) exceeds 1; or output a signal indicating the zero-pulse step (Z) if the integrated output (u) is less than 1; wherein the comparator output (y) is fed back to an input of the adder, thereby forming a closed-loop control for voltage regulation.

According to the second aspect of the present application, there is provided a wireless USM drive control system, comprising: an ultrasonic motor; a high-frequency inverter configured to convert DC power into high-frequency AC power; a first wireless power transfer channel electrically connected to the inverter, including a first transmitting coil electrically connected to the inverter through a first compensation unit and a first receiving coil electrically connected to a stator of the motor, wherein the first transmitting coil is configured to generate a high-frequency magnetic field in response to the high-frequency AC power, and a second wireless power transfer channel electrically connected to the inverter and electrically independent of the first wireless power transfer channel, including a second transmitting coil electrically connected to the inverter through a second compensation unit and a second receiving coil electrically connected to the stator, wherein the second transmitting coil is configured to generate a high-frequency magnetic field in response to the high-frequency AC power, wherein, in response to the high-frequency magnetic field generated by the first and second transmitting coils, the first and second receiving coils are configured to resonate with the stator, thereby generating a high-frequency AC voltage across the stator, an autonomous optimal frequency adaptation control unit, configured to detect a zero-crossing of an output current of the inverter and based on the detection of the zero-crossing, to generate a drive trigger command, thereby triggering the inverter to adjust its frequency adaptively to operate autonomously at an optimal drive frequency of the USM by maintaining an output voltage and the output current of the inverter substantially in phase.

In an illustrative embodiment, the autonomous optimal frequency adaptation control unit comprises: a current sensor electrically connected to an output of the inverter and configured to sample the output current of the inverter; a zero-crossing comparator, communicatively coupled to the current sensor, and configured to output the trigger command upon detecting the zero-crossing of the sampled output current.

In a further illustrative or alternative embodiment, the wireless USM drive control system further comprises a FAPSM unit configured to dynamically adjust a pulse step amplitude and frequency of the output voltage of the inverter, thereby providing stepless voltage control for the motor.

Illustratively, the FAPSM unit comprises: a Σ-Δ modulator configured to generate a pulse step modulation signal indicating a requirement for a full-pulse step (F) or a zero-pulse step (Z) based on a target voltage ratio (δ*); and a multiplier, operatively coupled to the Σ-Δ modulator and the autonomous optimal frequency adaptation control unit, and configured to receive the pulse step modulation signal from the Σ-Δ modulator and the trigger command from the autonomous optimal frequency adaptation control unit, so as to determine switching mode of the high-frequency inverter.

Illustratively, the Σ-Δ modulator comprises: an adder configured to compute a difference between the target voltage ratio (δ*) and a comparator output (y); an integrator configured to integrate an output (e) of the adder to produce an integrated output (u); and a comparator configured to: output a signal indicating the full-pulse step (F) if the integrated output (u) exceeds 1; or output a signal indicating the zero-pulse step (Z) if the integrated output (u) is less than 1; wherein the comparator output (y) is fed back to an input of the adder, thereby forming a closed-loop control for voltage regulation.

Illustratively, the first compensation unit comprises a first compensation capacitor connected in series with the first transmitting coil, forming a first series resonant circuit; and the second compensation unit comprises a second compensation capacitor connected in series with the second transmitting coil, forming a second series resonant circuit; and a drive voltage applied to the first wireless power transfer channel by the high-frequency inverter maintains a 90-degree phase difference from a drive voltage applied to the second wireless power transfer channel by the high-frequency inverter.

According to the third aspect of the present application, there is provided a method for initiating operation of a wireless USM drive control system of the second aspect, comprising: (a) driving the USM at a fixed rated drive frequency to establish a stabilized inverter output current; (b) after the stabilized current is achieved, transitioning to a FAPSM scheme by dynamically adjusting a drive frequency of the USM based on real-time feedback of the inverter output current and modulating an output voltage of an inverter using a coordinated variable-frequency pulse-step modulation to maintain phase alignment between the output voltage and current.

Illustratively, driving the USM at the fixed rated drive frequency comprises setting the fixed rated drive frequency to match a resonant frequency of the USM during start up to generate a stable drive trigger command for initial current production prior to transitioning to the FAPSM scheme.

Illustratively, the FAPSM scheme comprises distributing positive and negative voltage pulses uniformly over multiple half-cycles to reduce current harmonics and oscillations.

According to the fourth aspect of the present application, there is provided a drive control circuit for a wireless USM, comprising: a high-frequency inverter configured to receive a DC power supply and convert DC power into high-frequency AC power; an integrated magnetic decoupler comprising: a first transmitting coil and a first receiving coil, and a second transmitting coil and a second receiving coil, wherein the first and second receiving coils are directly connected to a stator of the USM respectively; a compensation topology connected to the high-frequency inverter and configured to generate a high-frequency magnetic field in the first and second transmitting coils, wherein the first and second transmitting coils form part of the compensation unit respectively; wherein, when excited by the high-frequency magnetic field, the first and second receiving coils are configured to resonate with the stator respectively, thereby generating a high-frequency AC voltage across the stator to drive the USM.

In an illustrative embodiment, wherein a first transmitting coil and a first receiving coil form a first dual-coil structure, and a second transmitting coil and a second receiving coil form a second dual-coil structure, each dual-coil structure comprising vertically stacked.

Illustratively, the first dual-coil structure transmits and receives magnetic energy independently of the second dual-coil structure, with no mutual magnetic interference therebetween and the second dual-coil structure transmits and receives magnetic energy independently of the first dual-coil structure, with no mutual magnetic interference therebetween, such that the first transmitting coil couples energy exclusively to the first receiving coil, without coupling to the second transmitting or receiving coil and the second transmitting coil couples energy exclusively to the second receiving coil, without coupling to the first transmitting or receiving coil.

Illustratively, the compensation topology comprises: a first compensation capacitor connected in series with the first transmitting coil, forming a first series resonant circuit; and a second compensation capacitor connected in series with the second transmitting coil, forming a second series resonant circuit.

Illustratively, the high-frequency AC power is delivered to the first transmitting coil via the first compensation capacitor and to the second transmitting coil via the second compensation capacitor, thereby inducing the high-frequency magnetic field in the first and second transmitting coils, respectively.

In a further illustrative or alternative embodiment, the stator comprises a piezoelectric material with capacitive properties, making the stator electrically equivalent to a series combination of a capacitor and a resistor, such that the inductance of the first and second receiving coils and the equivalent capacitance of the stator form a series resonant circuit when excited by the high-frequency magnetic field, generating the high-frequency AC voltage across the stator.

In a further illustrative or alternative embodiment, the drive control circuit further comprises an autonomous optimal frequency adaptation control unit configured to detect zero-crossings of an output current of the inverter in real-time based on variations in an equivalent impedance of the stator and to generate corresponding drive trigger commands to adjust a driving frequency of the motor by triggering the inverter.

Advantageously, the autonomous optimal frequency adaptation control unit comprises a current sensor configured to sample the output current of the inverter and a zero-crossing comparator configured to process the sampled output current and output a trigger command indicating when the output current crosses zero, thereby aligning the phase of the output voltage of the inverter and current.

In an illustrative embodiment, the drive control circuit further comprises a FAPSM unit configured to dynamically adjust a pulse step amplitude and frequency of the output voltage of the inverter, thereby providing stepless voltage control for the motor.

In a further illustrative or alternative embodiment, the FAPSM unit comprises a Σ-Δ modulator configured to generate a pulse step signal based on a target voltage ratio (δ*) and to trigger the inverter using the drive trigger command, thereby implementing frequency-adaptive pulse step modulation.

Advantageously, the drive trigger command from the autonomous optimal frequency adaptation control unit is integrated with a pulse step modulation signal to maintain frequency-adaptive pulse step modulation at varying drive frequencies and to ensure phase alignment between the output voltage of the inverter and current.

In an illustrative embodiment, the FAPSM unit further comprises a multiplier; and the Σ-Δ modulator comprising an adder configured to compute a difference between the target voltage ratio δ* and a comparator output (y); an integrator configured to process the adder's output (e); and a comparator configured to output a full-pulse step (F) if the integrator's output (u) exceeds 1; or to output a zero-pulse step (Z) if the integrator's output (u) is below 1, thereby forming a closed-loop control for voltage regulation.

According to the fourth aspect of the present application, there is provided a wireless USM drive control system, comprising: an ultrasonic motor; a high-frequency inverter configured to convert DC power into high-frequency AC power; a first and second wireless power transfer channel connected to the inverter respectively, wherein the first wireless power transfer channel includes a first transmitting coil and a first receiving coil directly connected to a stator of the motor, and the second wireless power transfer channel includes a second transmitting coil and a second receiving coil directly connected to the stator, and wherein the stator comprises a piezoelectric material that resonates with the first and second receiving coils when excited by a high-frequency magnetic field, generating a driving AC voltage; an autonomous optimal frequency adaptation control unit configured to detect zero-crossings of an inverter output current and to generate drive trigger commands to adjust a motor driving frequency; and a FAPSM unit configured to dynamically adjust a pulse step amplitude and frequency of the output voltage of the inverter, thereby providing stepless voltage control for the motor; wherein the drive trigger command from the autonomous optimal frequency adaptation control unit is integrated with a pulse step modulation signal to maintain frequency-adaptive pulse step modulation at varying drive frequencies and to ensure phase alignment between the output voltage of the inverter and current.

Advantageously, a first transmitting coil and a first receiving coil form a first dual-coil structure, and a second transmitting coil and a second receiving coil form a second dual-coil structure, each dual-coil structure comprising vertically stacked.

Advantageously, the first dual-coil structure transmits and receives magnetic energy independently of the second dual-coil structure, with no mutual magnetic interference therebetween and the second dual-coil structure transmits and receives magnetic energy independently of the first dual-coil structure, with no mutual magnetic interference therebetween, such that the first transmitting coil couples energy exclusively to the first receiving coil, without coupling to the second transmitting or receiving coil and the second transmitting coil couples energy exclusively to the second receiving coil, without coupling to the first transmitting or receiving coil.

In an illustrative embodiment, the autonomous optimal frequency adaptation control unit comprises a current sensor configured to sample the output current of the inverter and a zero-crossing comparator configured to process the sampled output current and output a trigger command indicating when the output current crosses zero, thereby aligning a phase of the output voltage of the inverter and current.

In an illustrative embodiment, the FAPSM unit comprises a Σ-Δ modulator configured to generate a pulse step signal based on a target voltage ratio (δ*) and to trigger the inverter using the drive trigger command, thereby implementing frequency-adaptive pulse step modulation.

Based on the aforementioned embodiments of the present disclosure, there is provided a highly integrated wireless USM system and drive control circuit, which provides the following advantages:
1. Dual-coil configuration with magnetic decoupling. Two vertically stacked coils are performed to form an integrated magnetic decoupler (IMD) to improve power transfer efficiency by minimizing magnetic coupling between two coils, thereby effectively realizing the magnetic decoupling function.
2. An extremely simplified receiver architecture devoid of compensation components. The receiving end operates without capacitors, sensors, semiconductors, encoders, or auxiliary circuits, instead leveraging the inherent capacitive characteristic of the USM to form a resonant circuit with the receiving coil. This innovative approach eliminates traditional compensation networks and allows for a highly integrated and miniaturized design.
3. An autonomous optimal frequency adaptation control mechanism. Since the equivalent impedance of USM varies with the load, temperature, and other factors, its optimal driving frequency changes accordingly. Autonomous optimal frequency adaptation control allows the inverter to operate autonomously at the optimal driving frequency of the USM. The inverter output current iₜₐ is sampled by the current sensor, and then the corresponding drive trigger command C can be generated through the zero-crossing comparator, which is used to trigger the action of the inverter switches. Therefore, even if the impedance of the USM changes in real-time, the inverter frequency can be adjusted adaptively to operate autonomously at the optimal drive frequency of the USM by keeping the inverter output voltage and current in phase.
4. A FAPSM. The stepless regulation of the inverter output voltage is crucial for the flexible control of the speed of the wireless USM. Therefore, a frequency adaptive pulse step modulation scheme is proposed. By controlling the pulse step of the inverter output voltage, the equivalent output voltage of the inverter can be steplessly regulated. Firstly, the target voltage ratio δ* is input into the Σ-Δ modulator, and then the pulse step signal can be generated. Finally, the drive trigger command C generated by the autonomous optimal frequency adaptive control triggers the pulse step signal to control the inverter, thus realizing the frequency adaptive pulse step modulation of the inverter.

### BRIEF DESCRIPTION OF THE DRAWINGS

The accompanying figures, which are incorporated in and constitute a part of this specification, illustrate one or more embodiments of the invention and, together with the description, serve to explain the principles of the invention.

FIG. 1 is a system diagram of a wireless USM system with a highly integrated wireless power and drive system according to an embodiment of the present disclosure.

FIG. 2 is a circuit diagram of a simplified drive circuit for the wireless USM system of the embodiment of FIG. 1.

FIG. 3 is an equivalent circuit diagram of the single-phase stator drive circuit of the embodiment of FIG. 2.

FIG. 4 illustrates a further simplified equivalent circuit model of the single-phase drive circuit of the embodiment of FIG. 2.

FIG. 5 is an equivalent circuit diagram of the single-phase stator drive circuit of the embodiment of FIG. 1.

FIG. 6 is a diagram illustrating the construction of the integrated magnetic coupler of FIG. 1.

FIG. 7A is a system diagram of a wireless USM system with a highly integrated wireless power and drive system according to another embodiment of the present disclosure.

FIG. 7B is an equivalent circuit diagram of the single-phase stator drive circuit of the embodiment of FIG. 7A.

FIG. 8A is a system diagram of a wireless USM system with a highly integrated wireless power and drive system according to a further embodiment of the present disclosure.

FIG. 8B is an equivalent circuit diagram of the single-phase stator drive circuit of the embodiment of FIG. 8A.

FIG. 9 is a circuit diagram of a simplified drive circuit for the wireless USM system according to a further embodiment of the present disclosure including an autonomous optimal frequency adaptation control system.

FIG. 10 is a chart of the four effective switching modes of the full-bridge inverter.

FIG. 11 is a state transition diagram showing all possible state transitions and their corresponding voltage pulse steps.

FIG. 12 is a schematic diagram of a full-pulse step “F” and a zero-pulse step “Z”.

FIG. 13 is a schematic diagram of the FAPSM scheme.

FIG. 14 is a waveform diagram of the FASAM scheme for δ*=0.2 to δ*=0.8.

FIG. 15 is a waveform diagram of the output voltage and current of the A-phase inverter during the start-up process of the wireless USM.

FIG. 16A and FIG. 160B show the output voltage and current of the A-phase inverter for δ*=1 and δ*=0.7, respectively.

FIG. 17 shows the output voltage and current of the A-phase inverter for δ*=0.6 when the equivalent capacitance of the USM varies.

### DETAILED DESCRIPTION

Detailed reference is now made to the embodiments of the present application, with the figures illustrating one or more embodiments. The repeated use of figure labels throughout this specification serves to indicate similar features or elements of the present application. The following content is provided to facilitate a further understanding of the present application for those skilled in the art but does not limit the application in any form. It should be noted that various modifications and changes can be made by those skilled in the art without departing from the concept of the present application. For example, features shown or described as part of one embodiment may be used in conjunction with another embodiment to generate further implementations. Consequently, the present application is intended to encompass such variations and changes within the scope of the appended claims and their equivalents.

The present disclosure introduces a highly integrated wireless USM system with autonomous frequency adaptive pulse step modulation for application in completely sealed environments or environments where traditional cabling is impractical. This section elaborates on the system architecture, operational principles, components, and potential applications, providing a comprehensive description of the disclosure.

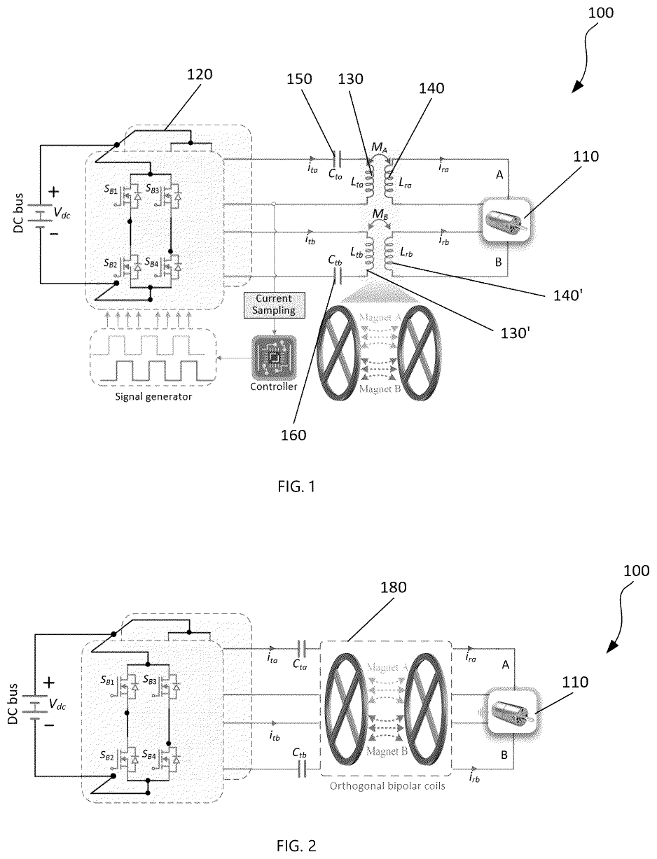

FIGS. 1-3 illustrate a first embodiment of the present application, providing a wireless USM system 100 with highly integrated wireless power and drive mechanism. This system 100 has an extremely simplified receiver architecture devoid of compensation components. The receiving end operates without capacitors, sensors, semiconductors, encoders, or auxiliary circuits, instead leveraging the inherent capacitive characteristic of the USM to form a resonant circuit with the receiving coil. Traditional compensation networks are not required.

As shown in FIG. 1, the system 100 mainly comprises: a USM 110, two full-bridge inverters 120, transmitting coils Lₜₐ 130 and L_{tb} 130′ and receiving coils Lᵣₐ 140 and L_{rb} 140′, and primary compensating capacitors Cₜₐ 150 and C_{tb} 160.

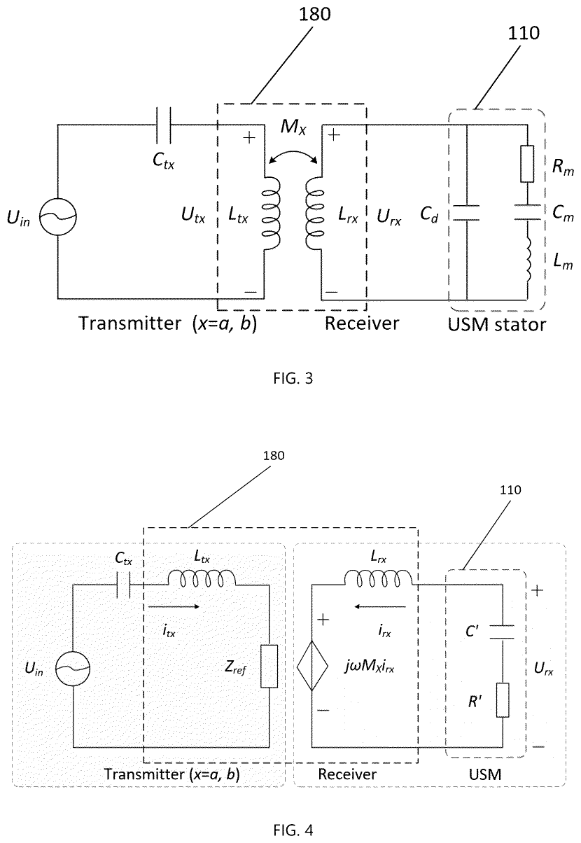

FIG. 2 is a circuit diagram of a simplified drive circuit for the wireless USM system of FIG. 1. According to the physical structure of the USM 110, the stator mechanical quantities can be equated to suitable electrical quantities by the equivalent circuit model. Therefore, the single-phase equivalent circuit of the proposed system 100 is shown in FIG. 3, where the USM 110 is directly driven by the orthogonal bipolar coils, and the simplified stator model of USM 110 is composed of series-parallel connections of Lₘ, C_{d}, Cₘ, and Rₘ. It should be noted that for simplicity of analysis, the load torque and other characteristics due to pressure, temperature and friction are not considered in the UMS model.

Under specific driving frequencies, the stator of USM 110 is externally capacitive. For further simplification, the equivalent stator model can be simplified to a series connection of the capacitor C′ and resistor R′, as shown in FIG. 4, where their values can be deduced as

$$\{ \begin{matrix}{C}^{′} = \frac{1 + {ω}^{2} {C}_{p}^{2} {R}^{2}}{{ω}^{2} {C}_{p} {R}^{2}} \\ {R}^{′} = \frac{R}{1 + {ω}^{2} {C}_{p}^{2} {R}^{2}}\end{matrix} \qquad ( 1 )$$

where the intermediate variables Cₚ and R can be expressed as

$$\{ \begin{matrix}{C}_{p} = {C}_{d} - \frac{{L}^{′}}{{R}_{m}^{2} + {( ω L )}^{2}} \\ R = {R}_{m} + \frac{{( ω {L}^{′} )}^{2}}{{R}_{m}}\end{matrix} \qquad ( 2 )$$

where L′=Lₘ−1/(ω²Cₘ).
The operating performance of USM 110 is highly dependent on the quality of the driving voltage, and the high-order harmonics of the input voltage may be detrimental to their stable operation. Therefore, an impedance-matching circuit is generally added before the stator to improve the operating characteristics of USM 110. In this disclosure, the bipolar magnetic coupler 180 is not only employed for wireless power and drive transfer but also as the inductive matching element for impedance matching of USM 110 to filter the input voltage so as to improve the load characteristics and drive capability.
According to FIG. 4, the impedance of the receiver side can be expressed as

$${Z}_{rx} = j ω {L}_{rx} + \frac{1}{j ω {C}^{′}} + {R}^{′} \qquad ( 3 )$$

where ω is the operating angular frequency.

The reflected impedance from the receiver to the transmitter can be deduced as

$${Z}_{ref} = \frac{{( ω {M}_{X} )}^{2}}{{Z}_{rx}} = \frac{{( ω {M}_{X} )}^{2}}{j ω {L}_{rx} + \frac{1}{j ω {C}^{′}} + {R}^{′}} \qquad ( 4 )$$

Based on Kirchhoff's voltage law, the following equation can be obtained as

$$\{ \begin{matrix}( j ω {L}_{tx} + \frac{1}{j ω {C}_{tx}} + {Z}_{ref} ) {i}_{tx} = {U}_{in} \\ {Z}_{rx} {i}_{rx} = j ω {M}_{X} {i}_{tx}\end{matrix} \qquad ( 5 )$$

To maximize transmission efficiency, both the transmitter and receiver operate at the resonant frequency. Therefore, the receiver inductance can be deduced as

$${L}_{rx} = \frac{{ω}^{2}}{{C}^{′}} \qquad ( 6 )$$

Accordingly, the output voltage URX can be calculated as follows

$${U}_{rx} = \frac{{U}_{in}}{{ω}^{2} {M}_{X} {C}^{′}} ( 1 + j ω {C}^{′} {R}^{′} ) \qquad ( 7 )$$

The proposed driving topology can boost the voltage output to facilitate the wireless driving of USM 110. By fully utilizing the capacitive characteristics of the USM 110, the motor can be driven wirelessly with only a bipolar magnetic coupler 180. The receiver magnetic coupler is not only used for wireless power transfer but also forms resonance with the USM 110 at a specific frequency to increase the drive voltage and compensate for the reactive power generated due to the capacitive nature of the USM 110. Therefore, the receiver side can be completely sealed for better integration, high robustness and maintenance-free operation.

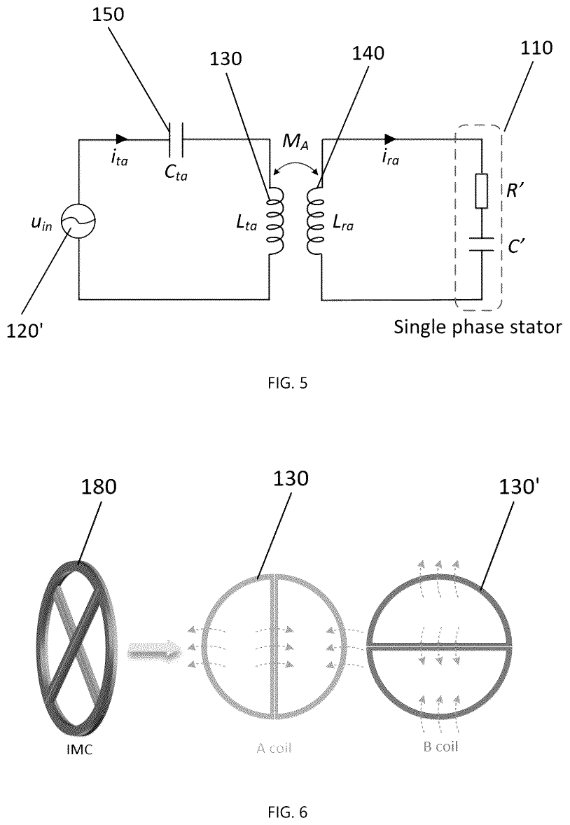

FIG. 5 shows the equivalent circuit of the A-phase of the highly integrated wireless USM system 100. The USM 110 operates as a two-phase motor, and since the equivalent circuit topology for the B-phase is the same as that of the A-phase, the circuit topology for the A-phase is analyzed for simplicity. In the configuration as shown in FIG. 5, the high-frequency inverter 120 depicted in FIG. 1 is equivalent to an alternating voltage source uᵢₙ 120′. The components Lₜₐ and Cₜₐ at the transmitting end form a series resonance circuit that generates a high-frequency magnetic field in the transmitting coil 130.

At the receiving end, the stator of the USM 110 is made of piezoelectric material with capacitive properties and can be represented as a series combination of capacitance C′ and resistance R′ as shown in FIG. 5. Under the excitation of the high-frequency magnetic field generated by the transmitting coil 130, the receiving coil Lᵣₐ 140 resonates in series with the equivalent capacitance C′ of the stator of the USM 110, thus generating a high-frequency alternating voltage across the stator of the USM 110, which induces the stator to vibrate according to the inverse piezoelectric effect. It should be noted that the compensation topology at the transmitting end is not limited to the series compensation of the inductor and capacitor. Those skilled in the art will recognize that various other compensation topologies may also be applicable at the transmitter end.

Thus, for the embodiment of the present disclosure shown in FIG. 5, the relationship between the circuit parameters is as follows:

$${ω}^{2} {L}_{ta} {C}_{ta} = 1 \qquad ( 8 )$$

$${ω}^{2} {L}_{ra} {C}^{′} = 1 \qquad ( 9 )$$

where ω is the angular frequency of the system at the resonant frequency, satisfying ω=2πf and f is the resonant frequency.

As shown in FIG. 1, this system 100 has an extreme simplicity of the receiving end. The inherent capacitive properties of the USM 110 are fully utilized so that the USM 110 can resonate with the receiving coil 140 and 140′, thus allowing the USM 110 to operate under the excitation of high-frequency AC voltage generated through the resonant. In addition, there are no external compensating components such as capacitors, sensors, semiconductors, encoders, and auxiliary circuits on the receiving end, which greatly reduces system complexity and manufacturing costs.

In addition, USMs 110 are high-frequency AC motors, and the system is designed to resonate at specific high frequencies, typically in the range of tens to hundreds of kilohertz, depending on the characteristics of the USM 110. The highly integrated wireless USM system 100 proposed in the present disclosure is not only limited to motors with specific frequencies and those skilled in the art will recognize that the inverter frequency of the proposed system 100 in the present disclosure can be changed for USMs 110 with different driving frequencies. In the two-phase configuration, the A-phase and B-phase have the same topology, except that the two-phase drive voltages maintain a 90-degree phase difference, thereby maximizing the USM's torque output and speed characteristics. This can be achieved by controlling the output voltages of the A-phase and B-phase inverters 120 to have a 90-degree phase difference.

FIG. 6 illustrates a preferred embodiment of the coils. As shown in FIG. 6, two orthogonal bipolar coils for simultaneous wireless power, drive transfer are employed. The two orthogonal bipolar coils, i.e., the vertical bipolar coil (coil A) and the horizontal bipolar coil (coil B), are designed for wireless power and drive transfer.

Preferably, the transmitting coils 130 and 130′ and receiving coils 140 and 140′ are composed of the four Double-D type coils. The first and the second two Double-D type coils are laminated together and their position is perpendicular to each other. The receiving coils 140 and 140′ are formed and connected in the same way as the transmitting coils 130 and 130′. The coupling structure can transfer wireless energy to the targeted coils, while tremendously avoiding electromagnetic coupling with non-targeted coils. For example, the transmitting coil A 130 is designed to transfer energy to receiving coil A 140, while no energy is expected to transfer to transmitting coil B 130′ and receiving coil B 140′. Meanwhile, transmitting coil B 130′ is designed to transfer energy only to receiving coil B 140′, rather than transmitting coil A 130 and receiving coil A 140.

Thus, the orthogonal overlap construction allows the magnetic flux generated by coil A to be orthogonal to that of coil B, which means the mutual inductance between the two coils is theoretically zero, thus realizing the magnetic decoupling.

Thus, transmitting coil A 130 and receiving coil A 140 and transmitting coil B 130′ and receiving coil B 140′ form a highly integrated magnetic coupler (IMC) 180 or termed as integrated magnetic decoupler, i.e., IMD. Both refer to the same topology structure in this disclosure.

The proper magnetic coupler design is essential for the feasible operation of WPT systems, especially for multi-channel transfer WPT, since different coupler topologies induce flux with different directions. The design of the bipolar coils is highly beneficial in enhancing the power transfer capability as well as increasing the tolerance of coil misalignment. In addition, the integration of unipolar and bipolar coils facilitates the realization of multi-load wireless power transfer.

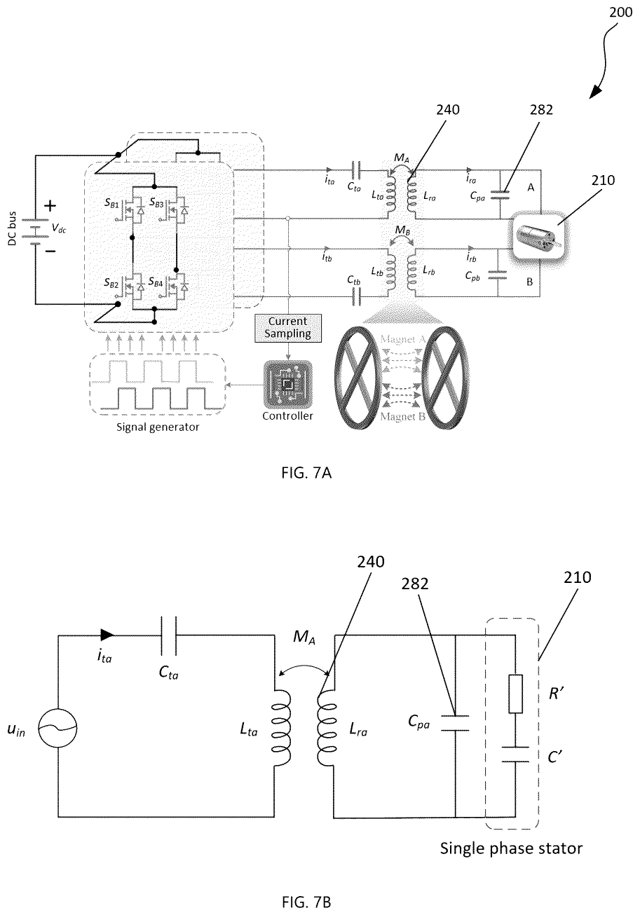

FIGS. 7A and 7B illustrate another embodiment of the present disclosure. Specifically, FIG. 7A depicts a highly integrated wireless USM system 200 employing a wireless power supply and drive mechanism. FIG. 7B shows the equivalent circuit for phase A of the highly integrated wireless USM system 200.

Similar to the embodiment illustrated in FIG. 1, the receiver structure is extremely simplified, omitting power semiconductor devices, position sensors, and microcontrollers, which significantly promotes high integration and maintenance-free operation. In the embodiment shown in FIG. 7A, a capacitor Cₚₐ 282 is connected in parallel at the single-phase output side of the USM 210. The rationale for this configuration is that if the equivalent capacitive reactance C′ of the single-phase stator of the USM 210 is very small, the equivalent inductance Lᵣₐ of the receiving coil 240 would need to be excessively large, which would increase the physical size of the receiving coil 240. Therefore, in this embodiment, a capacitor Cₚₐ 282 is connected in parallel at the single-phase output side of the USM 210 to increase the equivalent capacitive reactance, thereby reducing the size of the receiving coil 240.

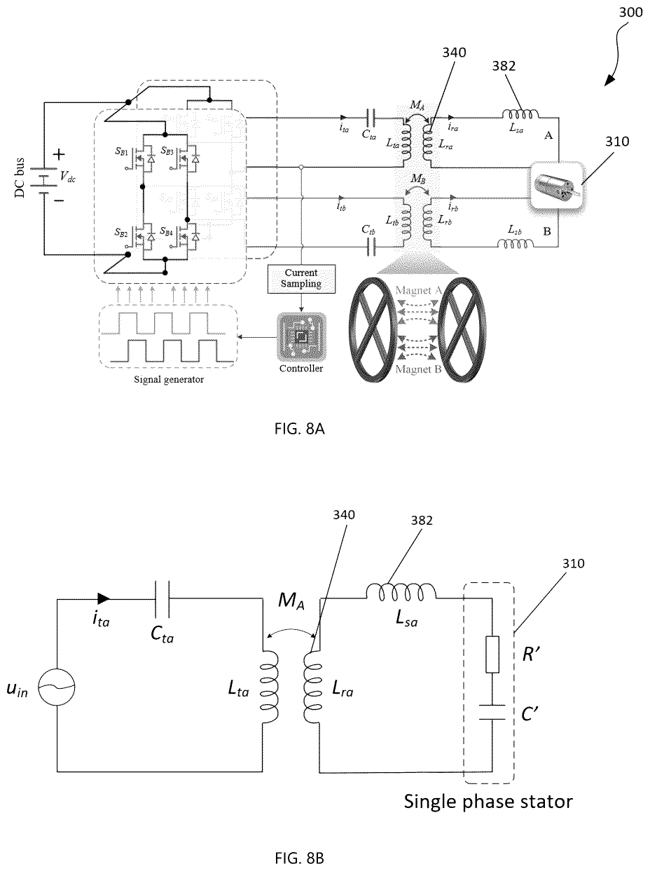

FIGS. 8A and 8B illustrate a further embodiment of the present disclosure. Specifically, FIG. 8A depicts a wireless USM system 300 employing a highly integrated wireless power supply and drive mechanism. FIG. 8B shows the equivalent circuit for phase A of the highly integrated wireless USM system 300.

Similar to the embodiments illustrated in FIGS. 1 and 7A, the receiver structure is extremely simplified, omitting power semiconductor devices, position sensors, and microcontrollers. This design significantly contributes to high integration and maintenance-free operation. In the embodiment shown in FIG. 8A, an inductor Lₛₐ 382 may be connected in series with the receiving coil 340. The rationale for this configuration is that if the equivalent capacitive reactance C′ of the single-phase stator of the USM 310 is very small, the equivalent inductance Lᵣₐ of the receiving coil 340 would need to be excessively large. Therefore, an inductor Lₛₐ 382 may be connected in series with the receiving coil 340 to reduce the required size of the receiving coil 340 itself.

In sum, as shown in above embodiments, the receiver side is extremely simplistic with no power semiconductors, position sensors, and microcontrollers, which greatly contributes to a high degree of integration and maintenance-free operation.

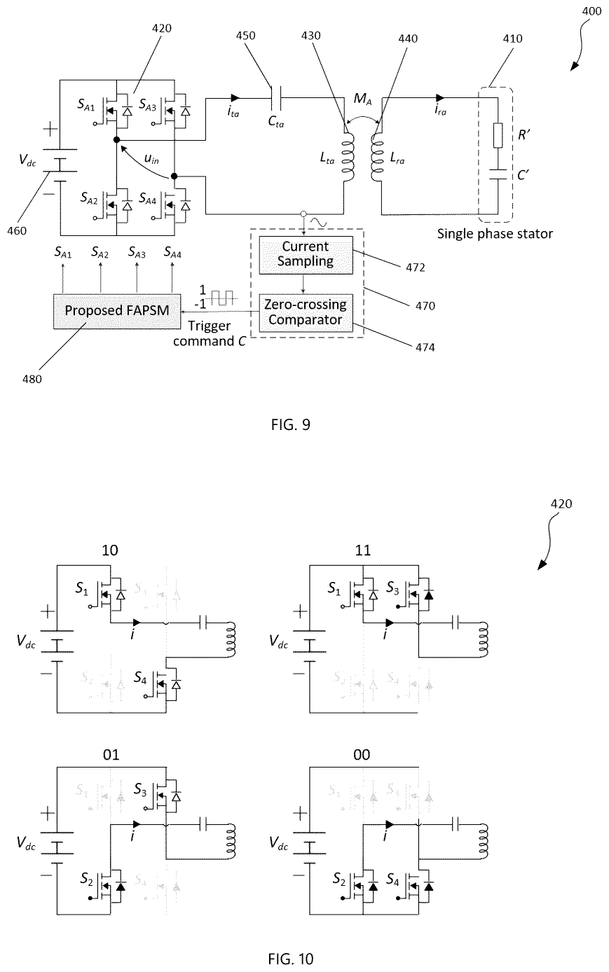

FIG. 9 illustrates another embodiment of the present application, relating to a highly integrated wireless USM system 400 with autonomous frequency adaptive pulse step modulation. Similar to the embodiment as shown in FIG. 1, this embodiment has a similar topology designed for operation in completely sealed environments without the need for batteries, power cables, or controllers at the receiving end, and further includes autonomous frequency adaptive pulse step modulation. In particular, FIG. 9 shows the equivalent circuit of the A-phase of the highly integrated wireless USM system 400. The system 400 comprises a USM 410, an inverter 420, a transmitting coil 430, a receiving coil 440, transmitting end compensation 450, DC voltage source 460, and current sampling circuit 472, as well as a controller and drive circuit.

FIG. 9 further includes an autonomous optimal frequency adaptation control unit 470 configured to detect zero-crossings of an inverter output current and to generate drive trigger commands to adjust a motor driving frequency.

In a further preferred embodiment, the system 400 further includes a FAPSM unit 480, in addition to the autonomous optimal frequency adaptation control unit 470, configured to dynamically adjust a pulse step amplitude and frequency of the output voltage of the inverter 420, thereby providing stepless voltage control for the motor. The drive trigger command C from the autonomous optimal frequency adaptation control unit 470 is integrated with a pulse step modulation signal to maintain frequency-adaptive pulse step modulation at varying drive frequencies and to ensure phase alignment between the output voltage of the inverter and current.

FIG. 9 further illustrates the schematic of the autonomous optimal frequency adaptation control mechanism. Considering that the equivalent impedance of the USM 410 varies due to factors such as load changes, temperature fluctuations, and operational time, the optimal driving frequency will change continuously. To solve this problem, an autonomous optimal frequency adaptation control for wireless USM 410 is proposed. Specifically, the system 400 continuously monitors the output current of the A-phase inverter using a current sensor 472 and then detects when the current crosses zero through the zero-cross comparator 474 and generates the trigger command C at the zero-cross moment. When the current crosses zero from negative to positive, pulse 1 is output, when the current crosses zero from positive to negative, pulse −1 is output. The rising and falling edges of trigger command C trigger the action of the inverter switches S₁, S₂, S₃ and S₄. Consequently, trigger command C provides the basis for frequency adjustment, ensuring that the output voltage and current remain in phase, thus operating at zero phase angle (ZPA). This is critical for optimal frequency adaptive control of wireless USMs 410, especially when the equivalent impedance of the USM 410 varies.

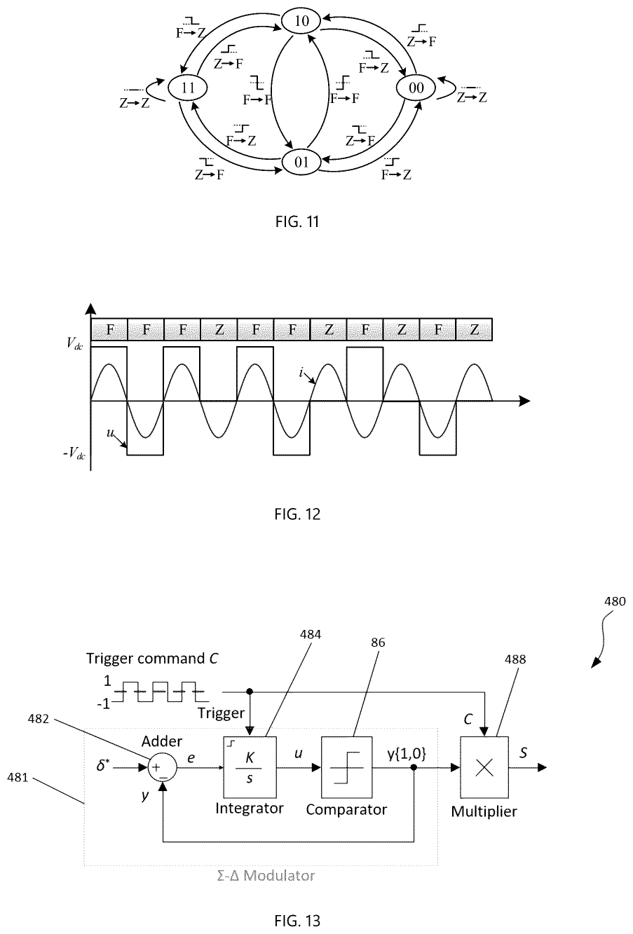

The four effective switching modes of the full-bridge inverter 420 are illustrated in FIG. 10. The switching mode transitions can generate voltage pulse steps. All possible state transitions and their corresponding voltage pulse steps are shown in FIG. 11. The full-bridge inverter 420 can produce two voltage pulse steps: full-pulse step and zero-pulse step, where switching states “10” and “01” generate full-pulse step, and states “00” and “11” produce zero-pulse step. As depicted in FIG. 12, “F” represents a full-pulse step, while “Z” denotes a zero-pulse step.

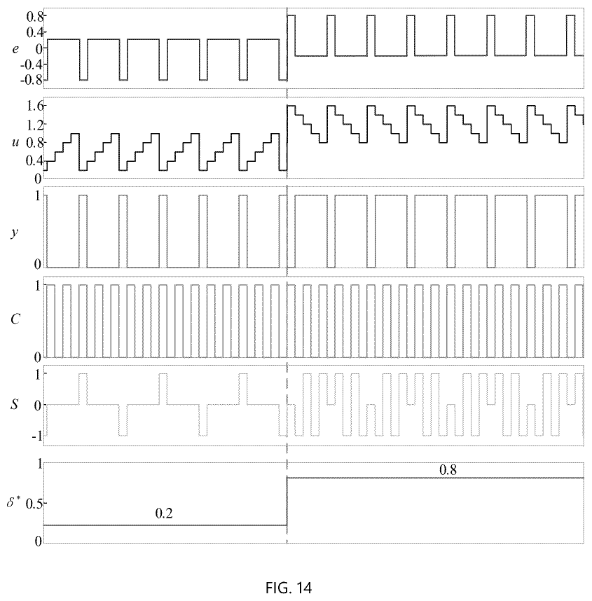

FIG. 13 shows the schematic of the proposed FAPSM 480 according to an embodiment of the present disclosure. The FAPSM 480 modulator comprises a Σ-Δ modulator 481, a multiplier 488. One of the inputs to the adder 482 is the given target voltage ratio δ*. The adder 482 computes the difference between δ* and the output y from the comparator 486, yielding an output signal e to the input of an integrator 484. The integrator's output, denoted as u, is fed into the comparator 486. If u exceeds 1, the comparator 486 outputs 1, indicating the requirement for a full-pulse step “F” to increase the output voltage. Conversely, if u is less than 1, the comparator 486 outputs 0, indicating the need for a zero-pulse step “Z” to decrease the output voltage and minimize the deviation from the target voltage ratio. The output y from the comparator 486 is connected to the multiplier's 488 input and also fed back to the adder's input, establishing a closed-loop control.

Additionally, as shown in FIG. 12, the full-pulse step “F” offers two alternatives: a positive full-pulse step “10” and a negative full-pulse step “01.” The selection between these two full-pulse steps must align with the direction of the inverter 420 output current. Therefore, the drive trigger command C is connected to the multiplier's 488 input. If the multiplier's 488 output is 1, the positive full-pulse step “10” is selected, activating the inverter switches S₁ and S₄ (while switches S₂ and S₃ are deactivated). If the output is −1, the negative full-pulse step “01” is chosen, activating switches S₂ and S₃ (while switches S₁ and S₄ are deactivated). The output ratio δ can be defined as the ratio of the fundamental frequency components of the maximum output voltage of the inverter 420, which is given by

$${u}_{in} = \frac{4 {V}_{dc}}{π} δ \qquad ( 10 )$$

where uᵢₙ is the fundamental frequency component of the inverter output voltage, and V_{dc} is the DC voltage.

According to the FAPSM principle, the output ratio δ can also be defined as follows:

$$δ = \frac{{N}_{F}}{{N}_{F} + {N}_{Z}} \qquad ( 11 )$$

where N_{F} and N_{Z} are the numbers of full-pulse steps “F”, and zero-pulse steps “Z”, respectively.

It should be noted that the zero-pulse step “Z” states “00” and “11” are redundant. The choice of either state does not affect the output waveform, regardless of the direction of the current change. However, the selection of zero-pulse step “Z” can influence the power loss of the inverter 420. When the outputs of the multiplier 488 in two adjacent cycles are not both 0, i.e., the two adjacent cycles are (1, 0), (0, 1), (−1, 0), or (0, −1), the system 400 alternates between the zero-pulse states “00” and “11” to prevent any switch of the inverter 420 from being continuously activated, thereby balancing power losses among the switches. If the outputs of the multiplier 488 in two adjacent cycles are both zero, the zero-pulse step states remain unchanged during these cycles to minimize the switching losses of the inverter 420.

Additionally, it should be emphasized that, unlike traditional fixed-frequency voltage modulation methods such as pulse width modulation (PWM) and pulse density modulation (PDM), the proposed FAPSM 480 features a variable pulse frequency. This adaptability allows the system 400 to effectively counteract resonance frequency detuning caused by variations in compensation parameters, load changes, and coupling coefficient fluctuations. Furthermore, the voltage and current of the inverter 420 are always in phase, ensuring ZPA operation. Significantly, the FAPSM 480 has a more uniform pulse distribution, which is conducive to the reduction of current harmonics.

It should be noted that the drive trigger command C required for the FAPSM 480 of the wireless USM system 400 may not be effectively generated due to the lack of current during the startup process. Therefore, during the startup phase, the system 400 should initially be set to operate at the resonant frequency of the USM 410. This approach can generate a fixed-frequency drive signal, allowing for stable current production. Once a stable current is established, the system 400 can switch to the FAPSM scheme. This approach combines the drive trigger command C from the autonomous frequency adaptation control with the FAPSM 480, resulting in a coordinated variable frequency modulation strategy that effectively adjusts the inverter's output voltage and frequency.

FIG. 14 shows the waveforms of the FASAM scheme at δ*=0.2 and δ*=0.8. It can be observed that over five half-periods, the number of full-pulse steps for δ*=0.2 and δ*=0.8 are 1 and 4, respectively, which is consistent with (4). In addition, different from the conventional PDM modulation, the positive and negative pulse distribution of the FAPSM scheme is more average and even, which is conducive to the reduction of current harmonics and oscillations.

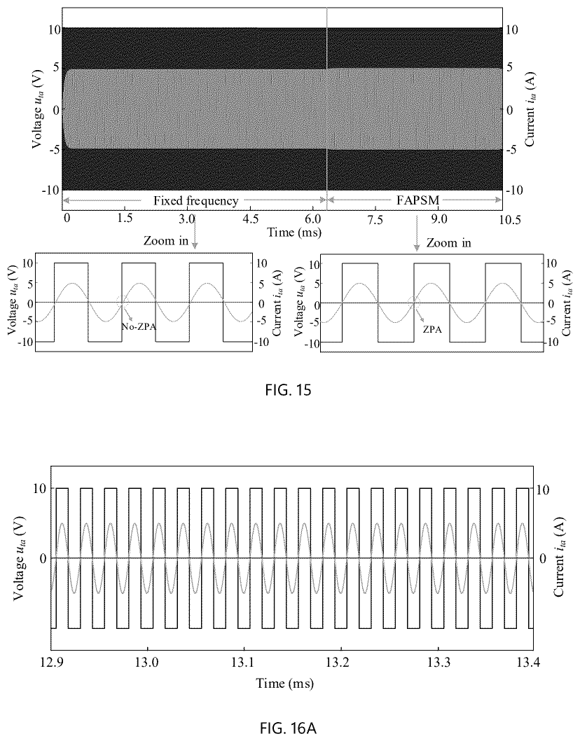

FIG. 15 shows the output voltage and current of the A-phase inverter during the startup process of the wireless USM 410. During the initial stage of the startup, the inverter frequency can be set to the rated drive frequency of the USM 410. Here we set it to a fixed frequency of 40 kHz and after generating a stable current, the system switches to the FAPSM scheme operation. As can be seen on the zoom-in graph, the voltage and current phases are out of phase at the fixed frequency of 40 kHz, with the current lagging slightly behind the voltage. However, when operating under the FAPSM scheme, the zoom-in graph shows that the voltage and current are in phase and the inverter switching frequency is automatically adjusted to 39.771 kHz. This effectively verifies the feasibility of the proposed startup scheme for wireless USMs 410.

FIG. 16A and FIG. 16B show the ability of the FASAM scheme to seamlessly regulate the inverter output voltage and current. In particular, FIG. 16A and FIG. 16B show the output voltage and current of the A-phase inverter for δ*=1 and δ*=0.7, respectively. It can be seen that under both control commands, the voltage and current are in phase. Therefore, it is proved that the proposed FAPSM scheme can realize the frequency adaption at any value of δ*. In addition, the RMS value of the inverter output current at δ*=1 is 3.526 A, while the RMS value of the inverter output current at δ*=0.7 is 2.468 A, which is 0.7 times the RMS value of δ*=1. Thus, the ability to regulate the inverter output voltage and current based on autonomous frequency adaptive pulse step modulation is effectively demonstrated. This effectively demonstrates that the proposed FAPSM scheme can steplessly regulate the inverter output voltage and current.

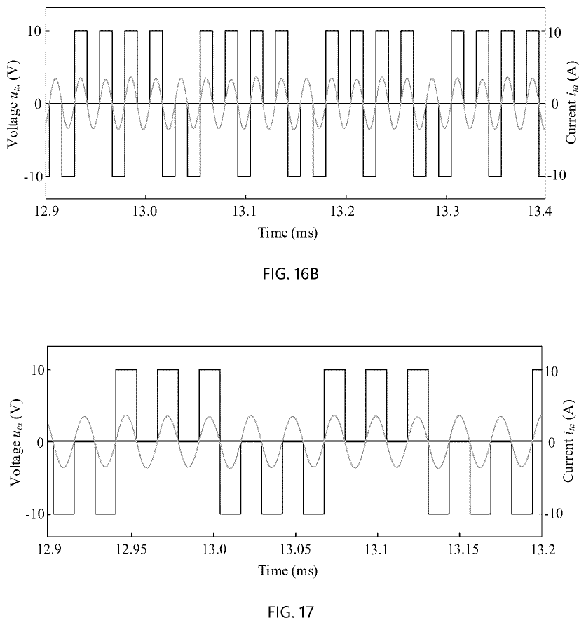

FIG. 17 shows the output voltage and current of the A-phase inverter for δ*=0.6 when the equivalent capacitance of the USM 410 varies due to factors such as operating time, load, and temperature. It can be seen that the voltages and currents are realized in phase and the system frequency is 39.472 kHz, which achieves the frequency adaptive compared to FIG. 16B. Therefore, the proposed FAPSM scheme enables autonomous optimal frequency regulation to overcome the resonant frequency drift caused by the variation of the temperature, load, and operating time of the USM. Meanwhile, the pulse step is also realized the autonomous frequency adaption to ensure that the current and voltage remain in phase.

In summary, a highly integrated wireless USM system 400 with autonomous frequency adaptive pulse step modulation is provided. This system 400 comprises several key components. Firstly, it includes a dual-coil configuration featuring vertically stacked coils designed as an IMD to enhance power transfer efficiency while minimizing magnetic coupling between the coils. It is important to note that the two coils of the IMD are not only limited to a round shape but can also be other shapes such as square.

Furthermore, the system 400 features a simplification of the receiving end that eliminates the need for external compensation components. This design utilizes the inherent capacitive properties of the USM 410 to achieve resonance with the receiving coil 440 and 440′ for improved integration and performance.

In addition to the hardware configuration, the system 400 incorporates an autonomous optimal frequency adaption control mechanism. This mechanism adjusts the driving frequency of the USM 410 in real-time based on variations in the equivalent impedance of USM 410 due to load changes, temperature fluctuations, and operational time. It utilizes the zero-crossing detection of the inverter output current to generate corresponding drive trigger commands to trigger the inverter action.

Moreover, the system 400 employs a frequency adaptive pulse step modulation method. This method allows for continuous and flexible regulation of the inverter output voltage by dynamically adjusting the pulse step amplitude and frequency to produce stepless voltage control for wireless USM 410.

Regarding the control specifics, the zero-crossing detection is achieved by sampling the inverter output current. Subsequently, the sampled current is processed through a zero-crossing comparator 474 which outputs a trigger command C indicating when the inverter output current crosses zero, thereby facilitating phase alignment between the inverter output voltage and current.

The frequency adaptive pulse step modulation is performed via a Σ-Δ modulator 481 that processes the given target voltage ratio δ* to generate command values for drive signal generation. This process ensures responsiveness to varying operational demands. The control system then integrates a drive trigger command C from the autonomous frequency adaptive control with the pulse step modulation signal. This integration ensures frequency adaptive pulse step modulation of the wireless USM 410 at different drive frequencies and maintains the inverter output voltages and currents in-phase.

A method for initiating the operation of the wireless USM 410 involves a specific sequence. The operation begins by initiating operation at the rated drive frequency of the USM 410 to establish a stabilized current. Following this stabilization, the system 400 transitions to frequency adaptive pulse step modulation to dynamically adjust the drive frequency and voltage according to the state of the USM 410 based on real-time feedback of the inverter output current.

This system is characterized by its operational capabilities. Specifically, the USMs are capable of operating without physical connectors and with batteries, thereby reducing electrical hazards and increasing safety in sensitive environments. The system design allows for compact integration suitable for application in environments where conventional cabling is impractical or hazardous, such as in robotic arms, enhancing mobility and flexibility. In confined environments such as underground pipelines or underwater propellers, the complexity associated with installing cables through holes can be avoided, preventing potential gas or liquid leaks.

Finally, the system offers adaptability in its design. The dual coil configuration can be adapted to a variety of shapes and sizes to suit different application requirements while maintaining magnetic decoupling characteristics. Similarly, the compensation topology at the transmitting end is not limited to series compensation of inductor and capacitor, and any other compensation structure can be adapted that can enable the generation of a high-frequency magnetic field in the transmitting coil.

The highly integrated wireless USM system with autonomous frequency adaptive pulse step modulation is suitable for a variety of applications, including but not limited to:
Robotics: Provides flexible and efficient power solutions for robotic joints, actuators, and other components requiring mobility and precision.
Medical devices: Enables wireless control in surgical tools, prosthetics, and other medical devices where reliability and safety are crucial.
Consumer electronics: Powers devices such as handheld tools, drones, and portable equipment that require compact designs and reduced wiring complexity.
Automotive applications: Supports wireless power solutions for electric vehicles and autonomous systems, enhancing the convenience of charging and control.
Fully closed environments like underground pipelines or underwater thrusters: This system avoids the complexity of installing cables through holes, thereby preventing potential gas or liquid leaks.

Additionally, the frequency adaptive pulse step modulation enables precise control of the drive frequency and voltage for USMs. By continuously adjusting the pulse steps, the system can respond quickly to changes in operating requirements. This feature is critical for the above applications that require precise control.

The embodiments described herein are presented for purposes of illustration and not limitation. It is to be understood that the disclosure is not limited to the specific embodiments disclosed, but is capable of considerable modification, rearrangement, and combination without departing from the spirit and scope of the claims.

Any feature or element described as part of an embodiment may be combined with, or substituted for, any feature or element of another embodiment unless otherwise stated or logically precluded. The mere description of an embodiment with a particular feature or advantage shall not be construed to limit the claims to that feature or advantage. One of ordinary skill in the art will recognize that certain trade-offs may be made to achieve optimal system performance for a specific application, and an embodiment lacking a particular described advantage may still be within the scope of the claims.

1. A drive control circuit for a wireless ultrasonic motor, comprising:
a high-frequency inverter configured to receive DC power and convert the DC power into high-frequency AC power; and
at least one power conversion stage, comprising:
a transmitter electrically connected to the high-frequency inverter, the transmitter including a transmitting coil, and a compensation unit electrically connected between the high-frequency inverter and the transmitting coil, wherein the transmitter is configured to cause the transmitting coil to generate a high-frequency magnetic field in response to the high-frequency AC power; and
a receiver including a receiving coil directly and electrically connected to a stator of the ultrasonic motor;
wherein, in response to the high-frequency magnetic field generated by the transmitting coil, the receiving coil is configured to resonate with the stator, thereby generating a high-frequency AC voltage across the stator.

2. The drive control circuit of claim 1, further comprising an inductor connected in series with the receiving coil and/or a capacitor connected in parallel with the ultrasonic motor.

3. The drive control circuit of claim 1, further comprising an additional power conversion stage electrically independent of the at least one power conversion stage, wherein the at least one power conversion stage and the additional power conversion stage have the same topology.

4. The drive control circuit of claim 1, wherein the transmitting coil and the additional transmitting coil are vertically stacked to form a dual-coil structure, and the receiving coil and the additional receiving coil are vertically stacked to form an additional dual-coil structure.

5. The drive control circuit of claim 1, wherein:
the compensation unit comprises a compensation capacitor, the compensation capacitor connected in series with the transmitting coil forming a series resonant circuit to provide resonance compensation.

6. The drive control circuit of claim 1, wherein a drive voltage applied to the at least one power conversion stage by the high-frequency inverter maintains a 90-degree phase difference from a drive voltage applied to the additional power conversion stage by the high-frequency inverter.

7. The drive control circuit of claim 1, further comprising an autonomous optimal frequency adaptation control unit, configured to:
detect a zero-crossing of an output current of the high-frequency inverter; and
based on the detection of the zero-crossing, generate a drive trigger command, thereby triggering the high-frequency inverter to adjust its frequency adaptively to operate autonomously at an optimal drive frequency of the ultrasonic motor by maintaining an output voltage and the output current of the high-frequency inverter substantially in phase.

8. The drive control circuit of claim 7, wherein the autonomous optimal frequency adaptation control unit comprises:
a current sensor electrically connected to an output of the high-frequency inverter and configured to sample the output current of the high-frequency inverter;
a zero-crossing comparator, communicatively coupled to the current sensor, and configured to output the trigger command upon detecting the zero-crossing of the sampled output current.

9. The drive control circuit of claim 7, further comprising a frequency-adaptive pulse step modulation (FAPSM) unit configured to dynamically adjust a pulse step amplitude and frequency of the output voltage of the high-frequency inverter, thereby providing stepless voltage control for the motor.

10. The drive control circuit of claim 9, wherein the FAPSM unit comprises:
a Σ-Δ modulator configured to generate a pulse step modulation signal indicating a requirement for a full-pulse step or a zero-pulse step based on a target voltage ratio; and
a multiplier, configured to receive the pulse step modulation signal from the Σ-Δ modulator and the trigger command from the autonomous optimal frequency adaptation control unit, so as to determine switching mode of the high-frequency inverter.

11. The drive control circuit of claim 10, wherein the Σ-Δ modulator comprises:
an adder configured to compute a difference between the target voltage ratio and a comparator output;
an integrator configured to integrate an output of the adder to produce an integrated output; and
a comparator configured to:
output a signal indicating the full-pulse step if the integrated output exceeds 1; or
output a signal indicating the zero-pulse step if the integrated output is less than 1;
wherein the comparator output is fed back to an input of the adder, thereby forming a closed-loop control for voltage regulation.

12. A wireless ultrasonic motor drive control system, comprising:
an ultrasonic motor;
a high-frequency inverter configured to convert DC power into high-frequency AC power;
a first wireless power transfer channel electrically connected to the high-frequency inverter, including a first transmitting coil electrically connected to the high-frequency inverter through a first compensation unit and a first receiving coil electrically connected to a stator of the motor, wherein the first transmitting coil is configured to generate a high-frequency magnetic field in response to the high-frequency AC power, and
a second wireless power transfer channel electrically connected to the high-frequency inverter and electrically independent of the first wireless power transfer channel, including a second transmitting coil electrically connected to the high-frequency inverter through a second compensation unit and a second receiving coil electrically connected to the stator, wherein the second transmitting coil is configured to generate a high-frequency magnetic field in response to the high-frequency AC power,
wherein, in response to the high-frequency magnetic field generated by the first and second transmitting coils, the first and second receiving coils are configured to resonate with the stator, thereby generating a high-frequency AC voltage across the stator,
an autonomous optimal frequency adaptation control unit, configured to detect a zero-crossing of an output current of the high-frequency inverter and based on the detection of the zero-crossing, to generate a drive trigger command, thereby triggering the high-frequency inverter to adjust its frequency adaptively to operate autonomously at an optimal drive frequency of the ultrasonic motor by maintaining an output voltage and the output current of the high-frequency inverter substantially in phase.

13. The wireless ultrasonic motor drive control system of claim 12, wherein the autonomous optimal frequency adaptation control unit comprises:
a current sensor electrically connected to an output of the high-frequency inverter and configured to sample the output current of the high-frequency inverter;
a zero-crossing comparator, communicatively coupled to the current sensor, and configured to output the trigger command upon detecting the zero-crossing of the sampled output current.

14. The wireless ultrasonic motor drive control system of claim 12, further comprising a frequency-adaptive pulse step modulation (FAPSM) unit configured to dynamically adjust a pulse step amplitude and frequency of the output voltage of the high-frequency inverter, thereby providing stepless voltage control for the motor.

15. The wireless ultrasonic motor drive control system of claim 14, wherein the FAPSM unit comprises:
a Σ-Δ modulator configured to generate a pulse step modulation signal indicating a requirement for a full-pulse step (F) or a zero-pulse step based on a target voltage ratio; and
a multiplier, configured to receive the pulse step modulation signal from the Σ-Δ modulator and the trigger command from the autonomous optimal frequency adaptation control unit, so as to determine switching mode of the high-frequency inverter.

16. The wireless ultrasonic motor drive control system of claim 15, wherein the Σ-Δ modulator comprises:
an adder configured to compute a difference between the target voltage ratio and a comparator output;
an integrator configured to integrate an output of the adder to produce an integrated output; and
a comparator configured to:
output a signal indicating the full-pulse step if the integrated output exceeds 1; or
output a signal indicating the zero-pulse step if the integrated output is less than 1;
wherein the comparator output is fed back to an input of the adder, thereby forming a closed-loop control for voltage regulation.

17. The wireless ultrasonic motor drive control system of claim 12, wherein:
the first compensation unit comprises a first compensation capacitor connected in series with the first transmitting coil, forming a first series resonant circuit; and the second compensation unit comprises a second compensation capacitor connected in series with the second transmitting coil, forming a second series resonant circuit; and
a drive voltage applied to the first wireless power transfer channel by the high-frequency inverter maintains a 90-degree phase difference from a drive voltage applied to the second wireless power transfer channel by the high-frequency inverter.

18. A method for initiating operation of a wireless ultrasonic motor drive control system of claim 12, comprising:
(a) driving the ultrasonic motor at a fixed rated drive frequency to establish a stabilized inverter output current;
(b) after the stabilized current is achieved, transitioning to a frequency-adaptive pulse step modulation (FAPSM) scheme by dynamically adjusting a drive frequency of the ultrasonic motor based on real-time feedback of the inverter output current and modulating an output voltage of a high-frequency inverter using a coordinated variable-frequency pulse-step modulation to maintain phase alignment between the output voltage and current.

19. The method of claim 18, wherein driving the ultrasonic motor at the fixed rated drive frequency comprises setting the fixed rated drive frequency to match a resonant frequency of the ultrasonic motor during start up to generate a stable drive trigger command for initial current production prior to transitioning to the FAPSM scheme.

20. The method of claim 18, wherein the FAPSM scheme comprises distributing positive and negative voltage pulses uniformly over multiple half-cycles to reduce current harmonics and oscillations.
